(19) United States
(12) Patent Application Publication
(10) Pub. No.: US 2008/0160182 A1
(43) Pub. Date: Jul. 3, 2008

(54) Electroluminescent Materials and Devices

(76) Inventors: Poopathy Kathirgamanathan, North Harrow (GB); Subramaniam Ganeshamurugan, London (GB); Richard Price, Manchester (GB)

Correspondence Address: David Silverstein;Andover-IP-Law, 44 Park Street, Suite 300, Andover, MA, 01810, US

(21) Appl. No.: 11/795,007

(22) PCT Filed: Jan. 19, 2006
(86) PCT No.: PCT/GB2006/000169

§ 371 Date: Jul. 10, 2007

(30) Foreign Application Priority Data
Jan. 22, 2005 (GB) 0501426.1

(51) Int. Cl. B05D 5/12

(52) U.S. Cl. 427/126.5

(57) ABSTRACT

A method of spin coating electroluminescent organo metallic by coating the anode with a polymer before spin coating.

The present invention relates to electroluminescent materials and to electroluminescent devices.

Materials that emit light when an electric current is passed through them are well known and used in a wide range of display applications. Devices which are based on inorganic semiconductor systems are widely used. However these suffer from the disadvantages of high energy consumption, high cost of manufacture, low quantum efficiency and the inability to make flat panel displays. Organic polymers have been proposed as useful in electroluminescent devices, but it is not possible to obtain pure colours; they are expensive to make and have a relatively low efficiency. Another electroluminescent compound which has been proposed is aluminium quinolate, but it requires dopants to be used to obtain a range of colours and has a relatively low efficiency.

Patent application WO98/58037 describes a range of transition metal and lanthanide complexes which can be used in electroluminescent devices which have improved properties and give better results. Patent Applications PCT/GB98/01773, PCT/GB99/03619, PCT/GB99/04030, PCT/GB99/04024, PCT/GB99/04028 and PCT/GB00/00268 describe electroluminescent complexes, structures and devices using rare earth chelates. U.S. Pat. No. 5,128,587 discloses an electroluminescent device which consists of an organometallic complex of rare earth elements of the lanthanide series sandwiched between a transparent electrode of high work function and a second electrode of low work function, with a hole conducting layer interposed between the electroluminescent layer and the transparent high work function electrode, and an electron conducting layer interposed between the electroluminescent layer and the electron injecting low work function anode. The hole conducting layer and the electron conducting layer are required to improve the working and the efficiency of the device. The hole transporting layer serves to transport holes and to block the electrons, thus preventing electrons from moving into the electrode without recombining with holes. The recombination of carriers therefore mainly takes place in the emitter layer.

A class of electroluminescent compounds which have been disclosed as useful in electroluminescent devices are organo metal complexes of ruthenium, rhodium, palladium, osmium, iridium or platinum. To form these devices the layers are deposited in sequence on a substrate, typically a conductive transparent substrate such as an indium tin oxide.

Another compound which has been disclosed as useful in electroluminescent devices is zirconium quinolate which can be doped with a dye to change the colour of the emitted light.

The electroluminescent layer has been deposited by vacuum deposition which produces an even layer with a controlled thickness. However in scaling up the manufacture of electroluminescent devices vacuum deposition is expensive and requires specialist equipment and very high quality control.

A system for depositing a layer of material onto a surface is by spin coating in which the surface to be coated is placed in a solution of the material in a spin coater and the layer is deposited by centrifugal action.

However it has been found that the use of spin coating on an indium tin oxide glass substrate is not practical for some electroluminescent materials and, even if a layer of hole transporting material is deposited on the substrate it has nor proved possible to spin coat the organo metallic ruthenium, rhodium, palladium, osmium, iridium or platinum layer satisfactorily or to deposit zirconium quinolate.

We have now found that the organo metallic electroluminescent layer can be deposited satisfactorily by spin coating if the substrate is coated with a suitable polymer layer.

According to the invention there is provided a method of forming an electroluminescent device comprising an anode, a layer of an electroluminescent organo metallic complex and a cathode by spin coating the organo metallic complex onto the substrate in which the substrate is coated with a layer of a polymer.

The preferred polymers which can be used are electrically conductive polymers which can dissolve in a solvent, for example conjugated polymers as referred to below as hole transporting materials.

Other polymers which can be used are compounds which can be used as buffer materials in electroluminescent devices such as the solvent soluble phthalocyanines porphoryins such as

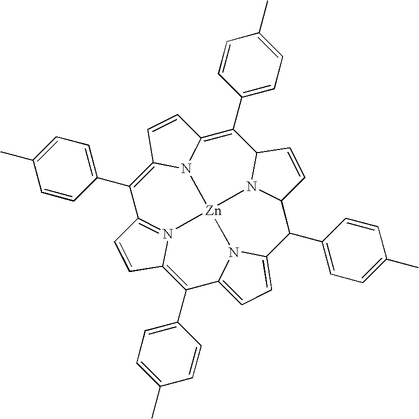

and metal diamino dianthracenes such as those of formulae

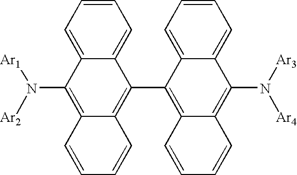

Particularly suitable polymers are polyethylene dioxythiophene polystyrene sulphonates.

In a preferred electroluminescent device there is (1) a transparent electrically conductive anode on which is deposited the layer of the polymer (2) a layer of a hole transporting material (3) a layer of the electroluminescent organo metallic complex (4) a layer of an electron transmitting material and (5) a cathode.

The preferred thickness of the polymer layer is from 50 to 150 nanometres and the polymer layer is preferably coated on the substrate by spin coating.

One type of preferred organo metallic complexes are the ruthenium, rhodium, palladium, osmium, iridium or platinum iridium complexes and, in particular, iridium complexes:

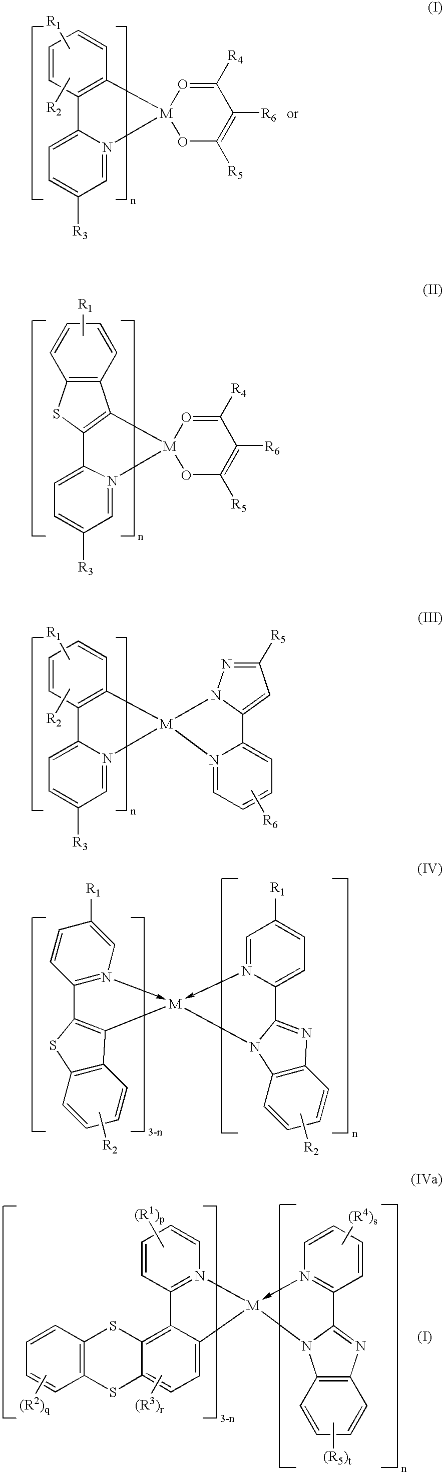

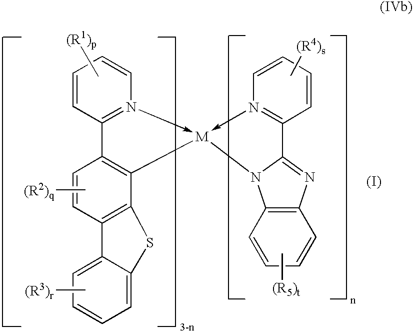

where R_{1, R}₂, R₃, R₄, R₅ and R₆ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, e.g. styrene, and where R₄, and R₅ can be the same or different and are selected from hydrogen, and substituted and unsubstituted hydrocarbyl groups such as substituted and unsubstituted aliphatic groups, substituted and unsubstituted aromatic, heterocyclic and polycyclic ring structures, fluorocarbons such as trifluoryl methyl groups, halogens such as fluorine or thiophenyl groups; R₁, R₂ and R₃ can also form substituted and unsubstituted fused aromatic, heterocyclic and polycyclic ring structures and can be copolymerisable with a monomer, M is ruthenium, rhodium, palladium, osmium, iridium or platinum and n+2 is the valency of M.

Preferably M is iridium.

The iridium or other metal complex can be mixed with a host material. Dopants which can be used include those referred to below.

The preferred thickness of the electroluminescent organo metallic complex is from 50 to 150 nanometers.

Other preferred organo metallic complexes are of formula M(L)ₙ and MO(L)ₙ₋₂ where M is a metal in a valency state n of greater than 3 and L is an organic ligand, the ligands L can be the same or different, e.g. M(L₁) (L₂) (L₃) (L₄) . . . or MO(L₁) (L₂) . . . .

Preferably the metal M is a transition metal such as titanium, zirconium or hafnium in the four valency state or vanadium, niobium or tantalum in the five valency state and in particular is zirconium quinolate.

Patent Application WO 2004/058913 the contents of which are included by reference discloses doped zirconium quinolates which can be used in the present invention.

Preferably the electroluminescent compound is doped with a minor amount of a fluorescent material as a dopant, preferably in an amount of 5 to 15% of the doped mixture.

As discussed in U.S. Pat. No. 4,769,292, the contents of which are included by reference, the presence of the fluorescent material permits a choice from among a wide latitude of wavelengths of light emission.

Useful fluorescent materials are those capable of being blended with the organo metallic complex and fabricated into thin films satisfying the thickness ranges described above forming the luminescent zones of the EL devices of this invention. While crystalline organo metallic complexes do not lend themselves to thin film formation, the limited amounts of fluorescent materials present in the organo metallic complex materials permits the use of fluorescent materials which are alone incapable of thin film formation. Preferred fluorescent materials are those which form a common phase with the organo metallic complex material. Fluorescent dyes constitute a preferred class of fluorescent materials, since dyes lend themselves to molecular level distribution in the organo metallic complex. Although any convenient technique for dispersing the fluorescent dyes in the organo metallic complexes can be undertaken, preferred fluorescent dyes are those which can be vacuum vapour deposited along with the organo metallic complex materials. Assuming other criteria, noted above, are satisfied, fluorescent laser dyes are recognized to be particularly useful fluorescent materials for use in the organic EL devices of this invention. Dopants which can be used include diphenylacridine, coumarins, perylene and their derivatives.

Useful fluorescent dopants are disclosed in U.S. Pat. No. 4,769,292.

The organometallic complex can be mixed with a dopant and co-deposited with it, preferably by dissolving the dopant and the organometallic complex in the solvent and spin coating the mixed solution.

The spin coating of the electroluminescent material can be carried out from a solution of the material in an inert solvent using conventional commercially available spin coating equipment. Suitable solvents include 1,4, dioxane.

The hole transporting material can be any of the hole transporting materials used in electroluminescent devices.

The hole transporting material can be an amine complex such as α-NBP, poly (vinylcarbazole), N,N′-diphenyl-N, N′-bis (3-methylphenyl) −1,1′-biphenyl −4,4′-diamine (TPD), an unsubstituted or substituted polymer of an amino substituted aromatic compound, a polyaniline, substituted polyanilines, polythiophenes, substituted polythiophenes, polysilanes and substituted polysilanes etc. Examples of polyanilines are polymers of:

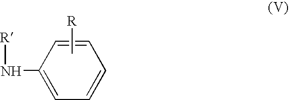

where R is in the ortho- or meta-position and is hydrogen, C1-18 alkyl, C1-6 alkoxy, amino, chloro, bromo, hydroxy or the group:

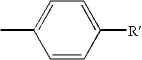

where R is alkyl or aryl and R′ is hydrogen, C1-6 alkyl or aryl with at least one other monomer of formula (V) above.

Alternatively the hole transporting material can be a polyaniline. Polyanilines. Polyanilines which can be used in the present invention have the general formula:

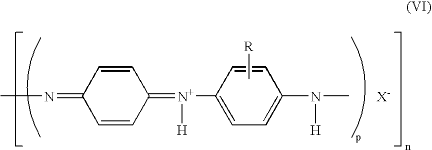

where p is from 1 to 10 and n is from 1 to 20, R is as defined above and X is an anion, preferably selected from Cl, Br, SO₄, BF₄, PF₆, H₂PO₃, H₂PO₄, arylsulphonate, arenedicarboxylate, polystyrenesulphonate, polyacrylate alkylsulphonate, vinylsulphonate, vinylbenzene sulphonate, cellulose sulphonate, camphor sulphonates, cellulose sulphate or a perfluorinated polyanion.

Examples of arylsulphonates are p-toluenesulphonate, benzenesulphonate, 9,10-anthraquinone-sulphonate and anthracenesulphonate. An example of an arenedicarboxylate is phthalate and an example of arenecarboxylate is benzoate.

We have found that protonated polymers of the unsubstituted or substituted polymer of an amino substituted aromatic compound such as a polyaniline are difficult to evaporate or cannot be evaporated. However we have surprisingly found that if the unsubstituted or substituted polymer of an amino substituted aromatic compound is deprotonated, then it can be easily evaporated, i.e. the polymer is evaporable.

Preferably evaporable deprotonated polymers of unsubstituted or substituted polymers of an amino substituted aromatic compound are used. The de-protonated unsubstituted or substituted polymer of an amino substituted aromatic compound can be formed by deprotonating the polymer by treatment with an alkali such as ammonium hydroxide or an alkali metal hydroxide such as sodium hydroxide or potassium hydroxide.

The degree of protonation can be controlled by forming a protonated polyaniline and de-protonating. Methods of preparing polyanilines are described in the article by A. G. MacDiarmid and A. F. Epstein, Faraday Discussions, Chem Soc. 88 P319, 1989.

The conductivity of the polyaniline is dependent on the degree of protonation with the maximum conductivity being when the degree of protonation is between 40 and 60%, for example about 50%.

Preferably the polymer is substantially fully deprotonated.

A polyaniline can be formed of octamer units. i.e. p is four, e.g.

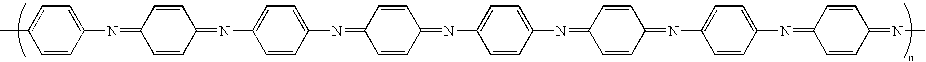

The polyanilines can have conductivities of the order of 1×10⁻¹ Siemen cm⁻¹ or higher.

The aromatic rings can be unsubstituted or substituted, e.g. by a C1 to 20 alkyl group such as ethyl.

The polyaniline can be a copolymer of aniline and preferred copolymers are the copolymers of aniline with o-anisidine, m-sulphanilic acid or o-aminophenol, or o-toluidine with o-aminophenol, o-ethylaniline, o-phenylene diamine or with amino anthracenes.

Other polymers of an amino substituted aromatic compound which can be used include substituted or unsubstituted polyaminonapthalenes, polyaminoanthracenes, polyaminophenanthrenes, etc. and polymers of any other condensed polyaromatic compound. Polyaminoanthracenes and methods of making them are disclosed in U.S. Pat. No. 6,153,726. The aromatic rings can be unsubstituted or substituted, e.g. by a group R as defined above.

Other hole transporting materials are conjugated polymers and the conjugated polymers which can be used can be any of the conjugated polymers disclosed or referred to in U.S. Pat. No. 5,807,627, WO90/13148 and WO92/03490.

The preferred conjugated polymers are poly (p-phenylenevinylene)-(PPV) and copolymers including PPV. Other preferred polymers are poly(2,5 dialkoxyphenylene vinylene) such as poly[(2-methoxy-5-(2-methoxypentyloxy-1,4-phenylene vinylene)], poly[(2-methoxypentyloxy)-1,4-phenylenevinylene)], poly[(2-methoxy-5-(2-dodecyloxy-1,4-phenylenevinylene)] and other poly(2,5 dialkoxyphenylenevinylenes) with at least one of the alkoxy groups being a long chain solubilising alkoxy group, polyfluorenes and oligofluorenes, polyphenylenes and oligophenylenes, polyanthracenes and oligo-anthracenes, polythiophenes and oligothiophenes. In PPV the phenylene ring may optionally carry one or more substituents, e.g. each independently selected from alkyl, preferably methyl, or alkoxy, preferably methoxy or ethoxy.

In polyfluorene, the fluorene ring may optionally carry one or more substituents e.g. each independently selected from alkyl, preferably methyl, alkoxy, preferably methoxy or ethoxy.

Any poly(arylenevinylene) including substituted derivatives thereof can be used and the phenylene ring in poly(p-phenylenevinylene) may be replaced by a fused ring system such as an anthracene or naphthalene ring and the number of vinylene groups in each poly(phenylenevinylene) moiety can be increased, e.g. up to 7 or higher.

The conjugated polymers can be made by the methods disclosed in U.S. Pat. No. 5,807,627, WO90/13148 and WO92/03490.

The thickness of the hole transporting layer is preferably 20 nm to 200 nm.

The polymers of an amino substituted aromatic compound such as polyanilines referred to above can also be used as buffer layers with or in conjunction with other hole transporting materials e.g. between the anode and the hole transporting layer. Other buffer layers can be formed of phthalocyanines such as copper phthalocyanine.

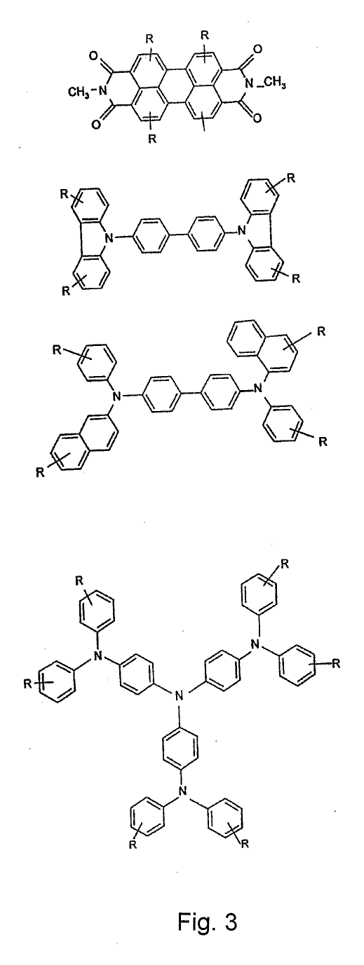

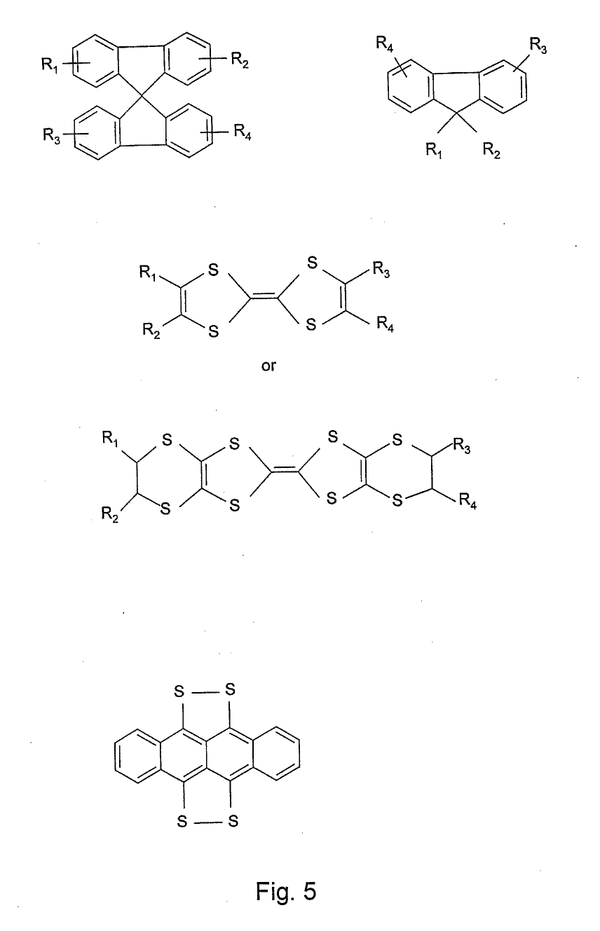

The structural formulae of some other hole transporting materials are shown in FIGS. 3, 4, 5, 6 and 7 of the drawings, where R, R¹, R², R³ and R⁴ can be the same or different and are selected from hydrogen, substituted and unsubstituted hydrocarbyl groups such as substituted and unsubstituted aliphatic groups, substituted and unsubstituted aromatic, heterocyclic and polycyclic ring structures, fluorocarbon groups such as trifluoromethyl, halogens such as fluorine or thiophenyl groups; R, R¹, R², R³ and R⁴ can also form substituted and unsubstituted fused aromatic, heterocyclic and polycyclic ring structures and can be copolymerisable with a monomer, e.g. styrene. X is Se, S or O, Y can be hydrogen, substituted or unsubstituted hydrocarboxyl groups, such as substituted and unsubstituted aromatic, heterocyclic and polycyclic ring structures, fluorocarbon groups such as trifluoromethyl, halogens such as fluorine, thiophenyl or nitrile groups.

Examples of R and/or R¹ and/or R² and/or R³ and/or R⁴ include aliphatic, aromatic and heterocyclic groups, alkoxy, aryloxy and carboxy groups, substituted and unsubstituted phenyl, fluorophenyl, biphenyl, naphthyl, fluorenyl, anthracenyl and phenanthrenyl groups, alkyl groups such as t-butyl, and heterocyclic groups such as carbazole.

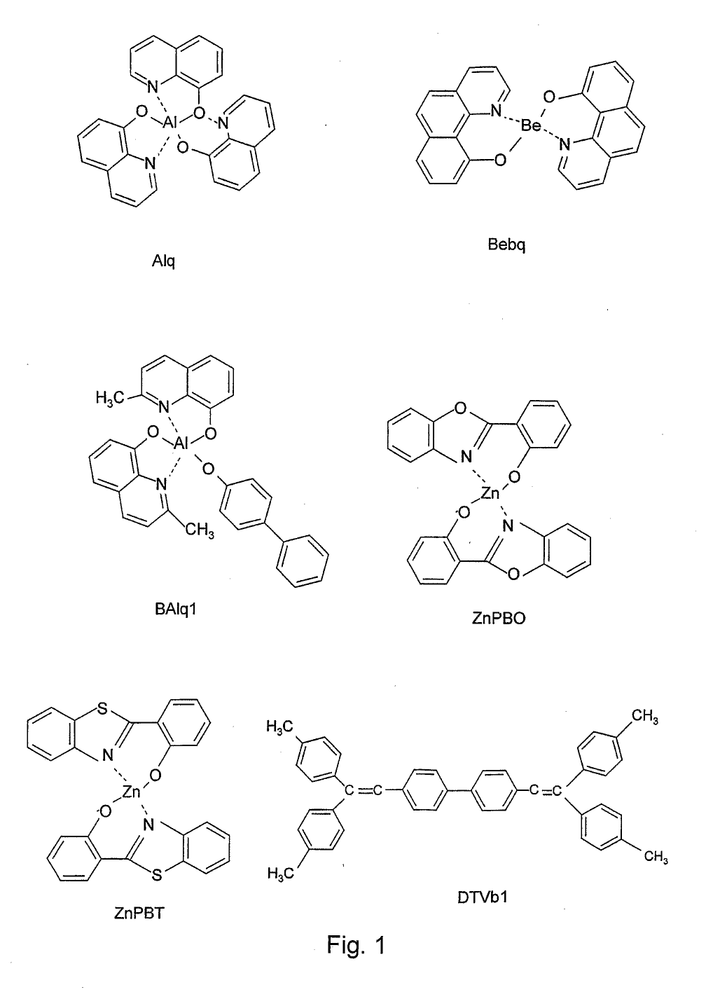

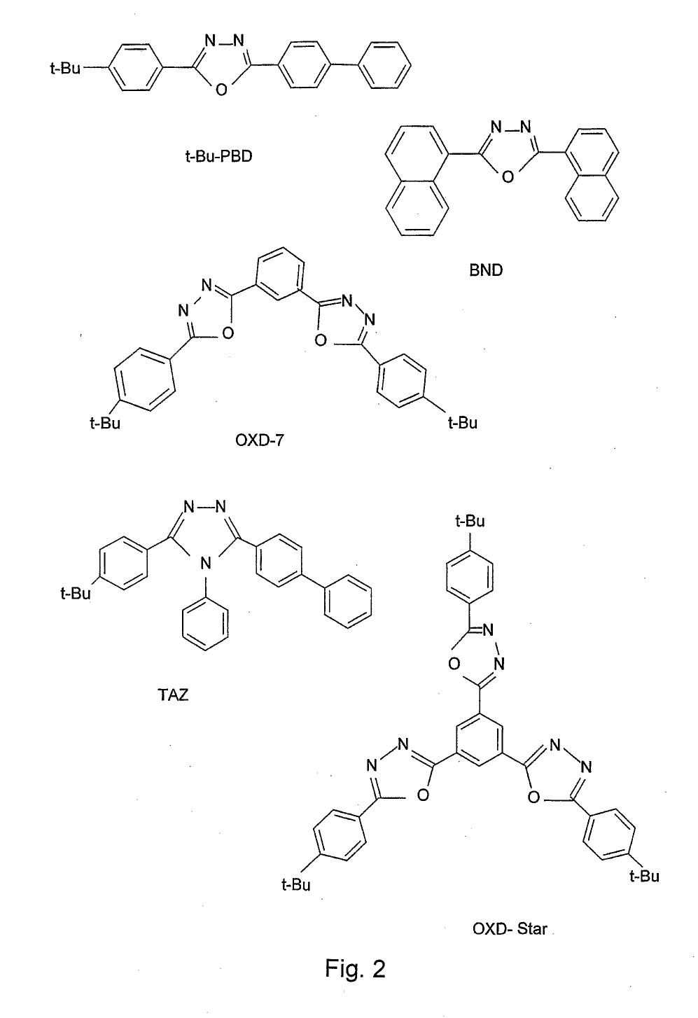

Optionally there is a layer of an electron injecting material between the anode and the electroluminescent material layer. The electron injecting material is a material which will transport electrons when an electric current is passed through. Electron injecting materials include a metal complex such as a metal quinolate, e.g. an aluminium quinolate, lithium quinolate, zirconium quinolate (Zrq₄), a cyanoanthracene such as 9,10 dicyanoanthracene, cyano substituted aromatic compounds, tetracyanoquinodimethane, a polystyrene sulphonate or a compound with the structural formulae shown in FIG. 1 or 2 of the drawings or Mx(DBM)ₙ where Mx is a metal and DBM is dibenzoyl methane and n is the valency of Mx e.g. Mx is aluminium or chromium. A Schiff base can also be used in place of the DBM moiety.

Instead of being a separate layer the electron injecting material can be mixed with the electroluminescent material and co-deposited with it.

Optionally the hole transporting material can be mixed with the electroluminescent material and co-deposited with it and the electron injecting materials and the electroluminescent materials can be mixed. The hole transporting materials, the electroluminescent materials and the electron injecting materials can be mixed together to form one layer, which simplifies the construction.

The first electrode is preferably a transparent substrate such as a conductive glass or plastic material which acts as the anode; preferred substrates are conductive glasses such as indium tin oxide coated glass, but any glass which is conductive or has a conductive layer such as a metal or conductive polymer can be used. Conductive polymers and conductive polymer coated glass or plastics materials can also be used as the substrate.

The cathode is preferably a low work function metal, e.g. aluminium, barium, calcium, lithium, rare earth metals, transition metals, magnesium and alloys thereof such as silver/magnesium alloys, rare earth metal alloys etc; aluminium is a preferred metal. A metal fluoride such as an alkali metal e.g. lithium fluoride, or rare earth metal or their alloys can be used as the second electrode, for example by having a metal fluoride layer formed on a metal.

The devices of the present invention can be used as displays in video displays, mobile telephones, portable computers and any other application where an electronically controlled visual image is used. The devices of the present invention can be used in both active and passive applications of such displays.

In known electroluminescent devices either one or both electrodes can be formed of silicon and the electroluminescent material and intervening layers of hole transporting and electron transporting materials can be formed as pixels on the silicon substrate. Preferably each pixel comprises at least one layer of an electroluminescent material and a (at least semi-) transparent electrode in contact with the organic layer on a side thereof remote from the substrate.

Preferably, the substrate is of crystalline silicon and the surface of the substrate may be polished or smoothed to produce a flat surface prior to the deposition of electrode, or electroluminescent compound. Alternatively a non-planarised silicon substrate can be coated with a layer of conducting polymer to provide a smooth, flat surface prior to deposition of further materials.

In one embodiment, each pixel comprises a metal electrode in contact with the substrate. Depending on the relative work functions of the metal and transparent electrodes, either may serve as the anode with the other constituting the cathode.

When the silicon substrate is the cathode an indium tin oxide coated glass can act as the anode and light is emitted through the anode. When the silicon substrate acts as the anode, the cathode can be formed of a transparent electrode which has a suitable work function; for example by an indium zinc oxide coated glass in which the indium zinc oxide has a low work function. The anode can have a transparent coating of a metal formed on it to give a suitable work function. These devices are sometimes referred to as top emitting devices or back emitting devices.

The metal electrode may consist of a plurality of metal layers; for example a higher work function metal such as aluminium deposited on the substrate and a lower work function metal such as calcium deposited on the higher work function metal. In another example, a further layer of conducting polymer lies on top of a stable metal such as aluminium.

Preferably, the electrode also acts as a mirror behind each pixel and is either deposited on, or sunk into, the planarised surface of the substrate. However, there may alternatively be a light absorbing black layer adjacent to the substrate.

In still another embodiment, selective regions of a bottom conducting polymer layer are made non-conducting by exposure to a suitable aqueous solution allowing formation of arrays of conducting pixel pads which serve as the bottom contacts of the pixel electrodes.

### EXAMPLES

In the examples the devices were constructed by coating an indium tin coated glass anode with the polymer followed by vacuum deposition of the hole transporting material, spin coating the layer of the electroluminescent material, vacuum coating of an electron transmitting material and a metal cathode.

### Example 1

### Spin Coated Devices Based on Compound P

Compound P was

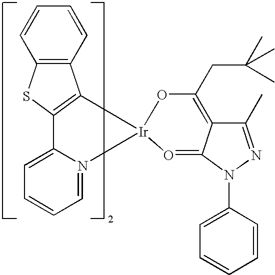

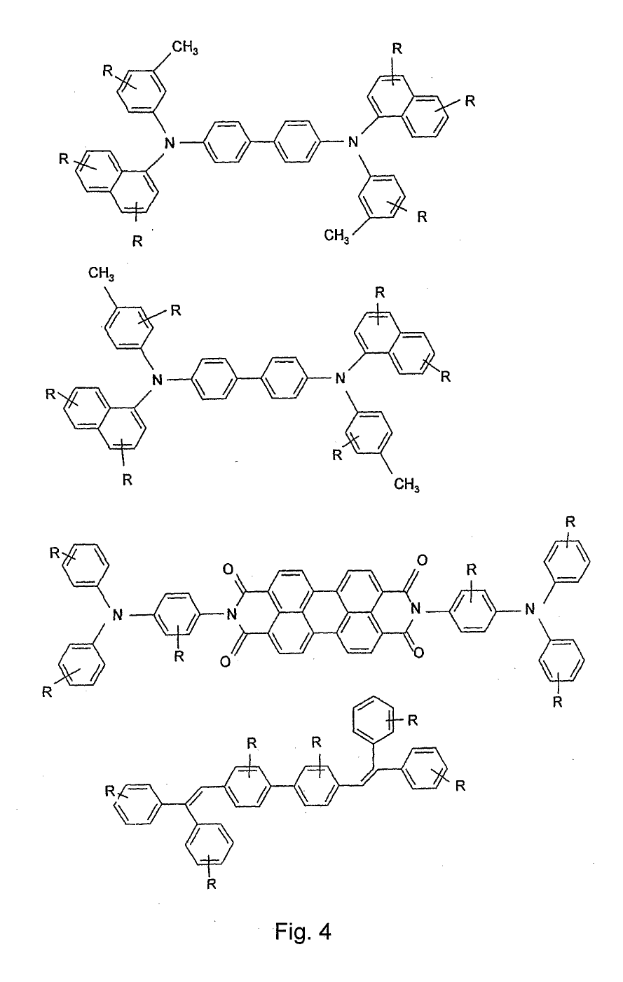

The compound P was mixed with CBP where CBP is as in FIG. 4b of the accompanying drawings where R is hydrogen.

Experimental Details

Spin Coater:

Spin coater used was a Semitec CPS 10 with a 6 inch plate.

Preparation of Indium Tin Oxide Coated Glass (ITO):

ITO (100 Ω/□, ˜20 nm) coated glass was cleaned using following procedure.
1. Ultra-sonication for 10 min. in Ethanol.
2. Ultra-sonication for 10 min. in 2-Propanone (Acetone).
3. Ultra-sonication for 10 min. in 2-Propanol (Iso-propanol).
4. Ultra-sonication for 10 min. in de-ionised water.
5. Drying in oven at 100° C. for 8 hours.

Spin Coating of PEDOT-PSS Layer:

A layer of polyethylene dioxythiophene polystyrene sulphonate (PEDOT-PSS) was spin coated onto the ITO/Glass from aqueous solution (Baytron P VPCH 8000 from Bayer).
1. A thin layer (88 nm) of PEDOT-PSS solution was applied to the entire ITO substrate surface.
2. A hot air-gun (1500 W) was directed at the surface of the substrate. The temperature of the substrate was 55° C.
3. Immediately the substrate was spun at 300 rpm for 5 seconds and then 3000 rpm for 15 seconds, after which the hot air flow was immediately ceased.

| Spin Speed (rpm) | Time (s) |
|---|---|
| 300 | 5 |
| 3000 | 15 |

4. The coated thin film was checked for evenness and then dried at 100° C. for 1 hour in a vacuum oven.

Vacuum Coating of α-NPB Layer:

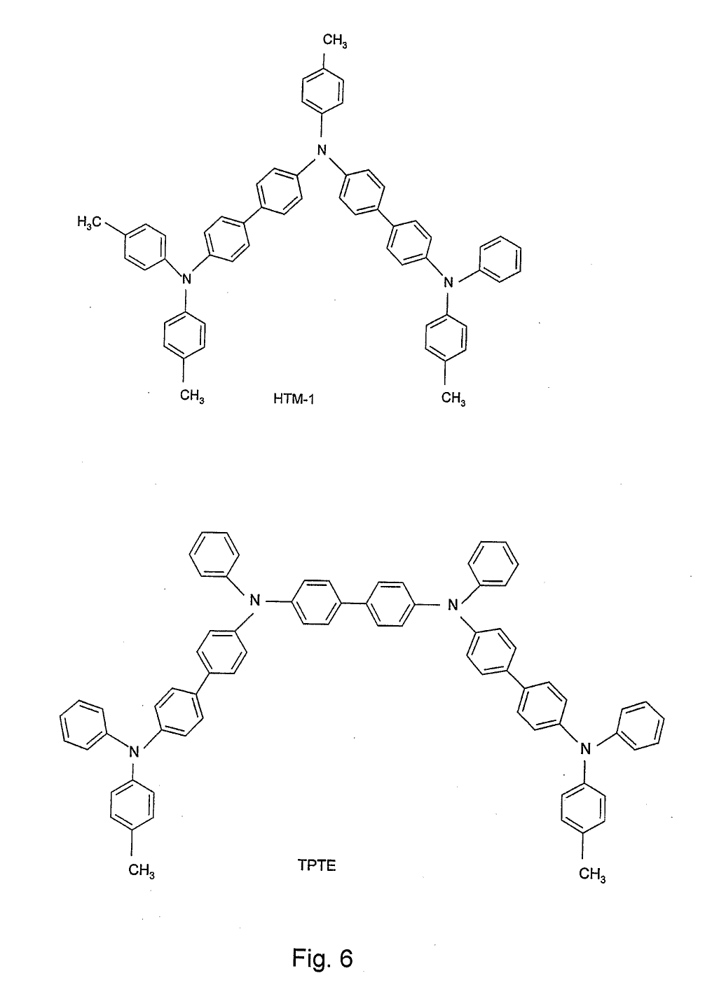

A layer of 40 nm of hole transporting material α-NPB of formula of FIG. 7 was vacuum coated onto the ITO/PEDOT-PSS substrate surface.

12.5% (w/w) Mixture of Compound P in CBP:

0.35 g of CBP and 0.05 g of Compound P were mixed and dissolved in 20 ml of 1,4-dioxane.
The solution was filtered to remove any undissolved particles for the spin coating.

Spin Coating of the Compound P/CBP Mixture Layer:
1. A layer (80 nm) of emitter solution was applied to entire ITO/PEDOT-PSS/α-NPB substrate surface.
2. Immediately the substrate was spun at 200 rpm for 5 seconds and then 2000 rpm for 15 seconds.

| Spin Speed (rpm) | Time (s) |
|---|---|
| 200 | 5 |
| 2000 | 15 |

3. The coated thin film was checked for evenness and then dried at 100° C. for 1 hour in a vacuum oven.

Vacuum Coating of BCP, Aluminium Quinolate (Alq₃) and LiF Layers:

A layer (6 nm) of bathocupron (BCP), 40 nm of Alq₃ and then 0.5 nm of LiF were vacuum coated onto the ITO/PEDOT-PSS/α-NPB/CBP:Compound P substrate surface.

Vacuum Coating of Cathode:

Aluminium (Al, 100 nm) was vacuum evaporated onto the ITO/PEDOT-PSS/α-NPB/CBP:Compound P/BCP/Alq₃/LiF substrate surface.

Device Configuration:

ITO (20 nm)/PEDOT-PSS (88 nm)/α-NPB (40 nm)/CBP:Compound P (12.5%; 80 nm)/BCP (6 nm)/Alq₃ (40 nm)/LiF (0.5 nm)/A1 (100 nm)

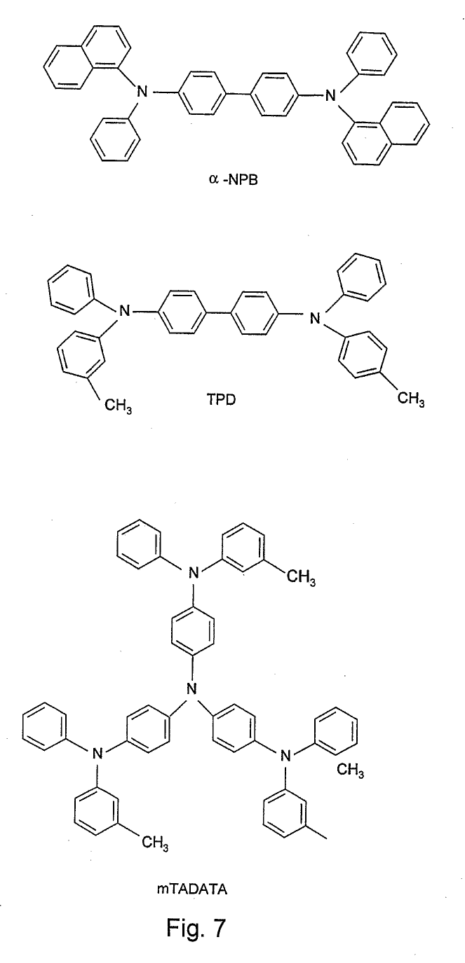

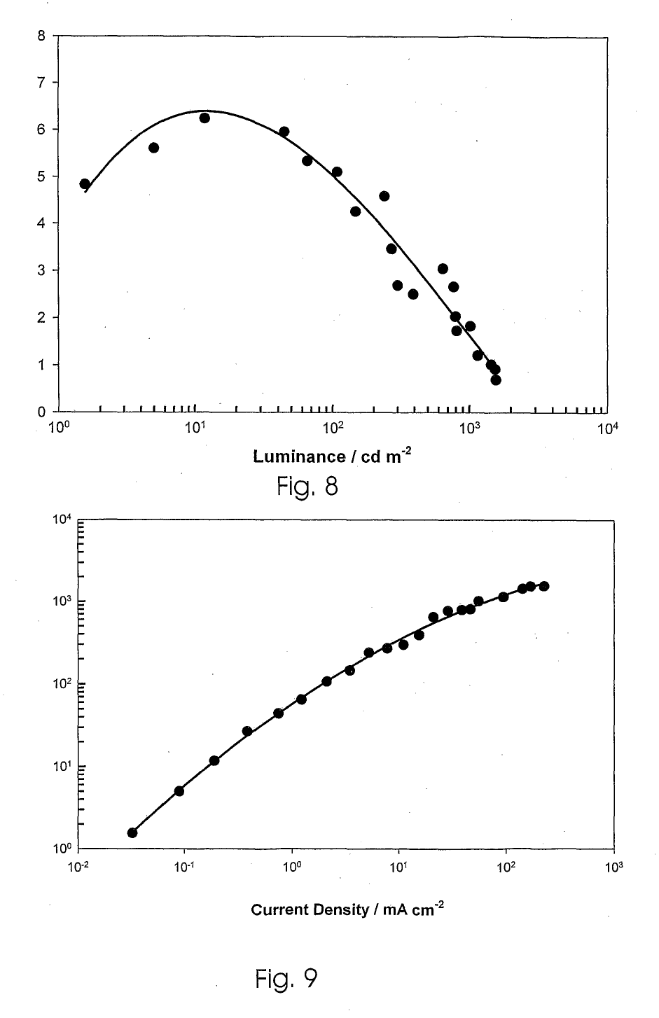

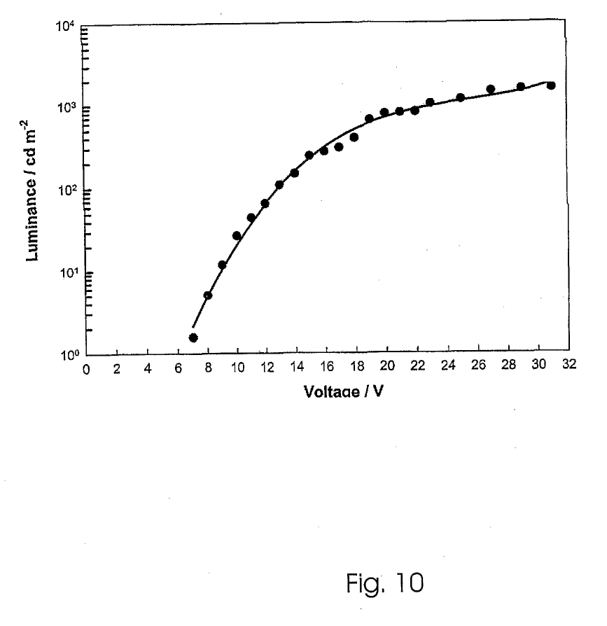

The properties of this device were measured and the results shown in FIGS. 8, 9 and 10.

### Example 2

### Spin Coated Devices Based on Zirconium Quinolate (Zrq₄)

Spin Coater:

Spin coater used was a Semitec CPS 10 with a 6 inch plate.

Preparation of ITO:

ITO (100 Ω/□,˜20 nm) coated glass was cleaned using following procedure.
1. Ultra-sonication for 10 min. in Ethanol.
2. Ultra-sonication for 10 min. in 2-Propanone (Acetone).
3. Ultra-sonication for 10 min. in 2-Propanol (Iso-propanol).
4. Ultra-sonication for 10 min. in de-ionised water.
5. Drying in oven at 100° C. for 8 hours.

Spin Coating of PEDOT-PSS Layer:

A layer of polyethylene dioxythiophene polystyrene sulphonate (PEDOT-PSS) was spin coated onto the ITO/Glass from aqueous solution (Baytron P VPCH 8000 from Bayer).
1. A thin layer (88 nm) of PEDOT-PSS solution was applied to the entire ITO substrate surface.
2. A hot air-gun (1500 W) was directed at the surface of the substrate. The temperature of the substrate was 55° C.
3. Immediately the substrate was spun at 300 rpm for 5 seconds and then 3000 rpm for 15 seconds, after which the hot air flow was immediately ceased.

| Spin Speed (rpm) | Time (s) |
|---|---|
| 300 | 5 |
| 3000 | 15 |

4. The coated thin film was checked for evenness and then dried at 100° C. for 1 hour in a vacuum oven.

Vacuum Coating of α-NPB Layer:

A layer of 40 nm of α-NPB was vacuum coated onto ITO/PEDOT-PSS substrate surface.

12.5% (w/w) Mixture of DPQA in Zrq₄:

0.175 g of Zrq₄ and 0.025 g of DPQA were mixed and dissolved in 20 ml of 1,4-dioxane. The solution was filtered to remove any undissolved particles for the spin coating.

DPQA is diphenylquinacridine.

Spin Coating of the DPQA/Zrq₄ Mixture Layer:
1. A layer (15 nm) of emitter solution was applied to entire ITO/PEDOT-PSS/α-NPB substrate surface.
2. Immediately the substrate was spun at 200 rpm for 5 seconds and then 2000 rpm for 15 seconds.

| Spin Speed (rpm) | Time (s) |
|---|---|
| 200 | 5 |
| 2000 | 15 |

3. The coated thin film was checked for evenness and then dried at 100° C. for 1 hour in a vacuum oven.

Vacuum Coating of Zrq₄ and LiF Layers:

A layer (20 nm) of Zrq₄ then 0.5 nm of LiF were vacuum coated onto the ITO/PEDOT-PSS/α-NPB/Zrq₄:DPQA substrate surface.

Vacuum Coating of Cathode:

Aluminium (Al, 100 nm) was vacuum evaporated onto the ITO/PEDOT-PSS/α-NPB/Zrq₄:DPQA/Zrq₄/LiF substrate surface.

Device Configuration:

ITO (20 nm)/PEDOT-PSS (88 nm)/α-NPB (40 nm)/Zrq₄:DPQA (12.5%; 15 nm)/Zrq₄ (20 nm)/LiF (0.5 nm)/Al (100 nm)

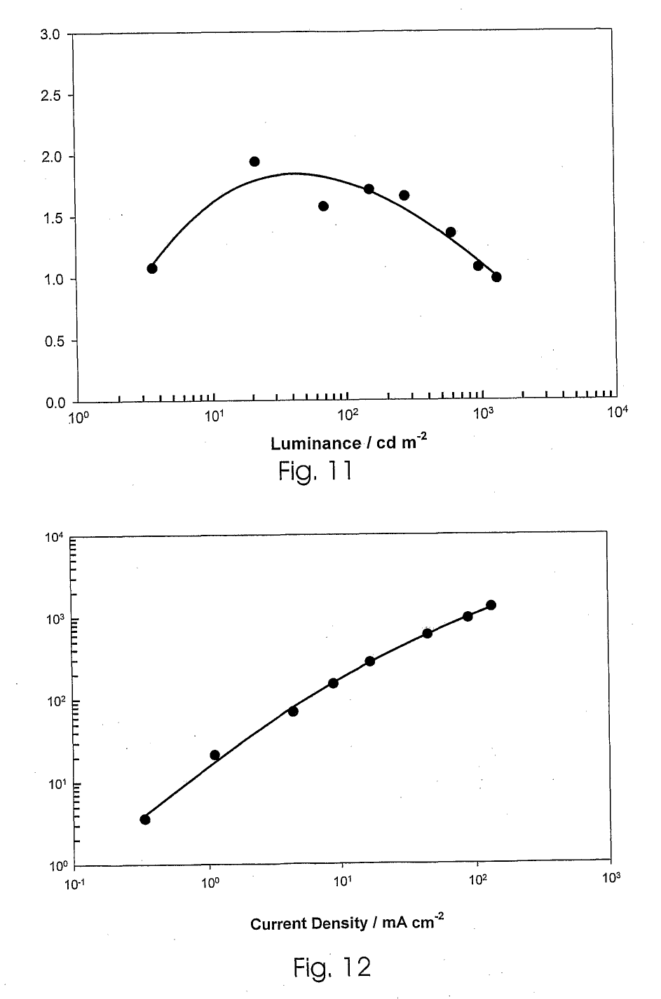

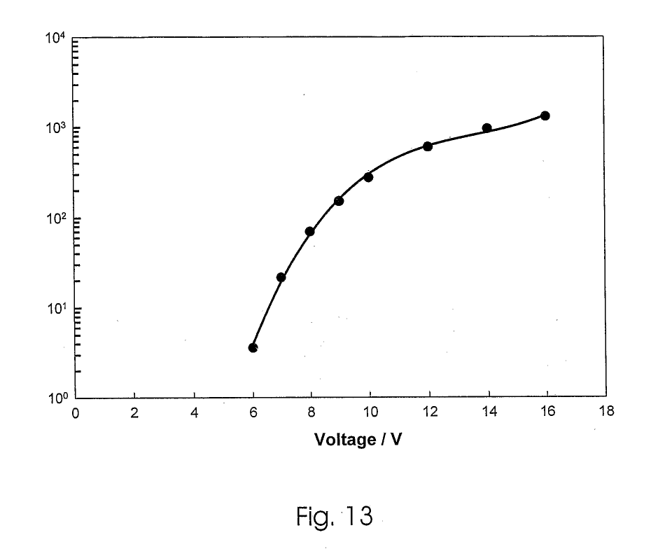

The properties of this device were measured and the results shown in FIGS. 11, 12 and 13.

### Example 3

### Spin Coated Devices Based on Compound Q

Compound Q is

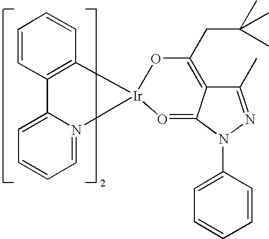

Spin Coater:

Spin coater used was a Semitec CPS 10 with a 6 inch plate.

Preparation of ITO:

ITO (100 Ω/□,˜20 nm) coated glass was cleaned using following procedure.
1. Ultra-sonication for 10 min. Ethanol.
2. Ultra-sonication for 10 min. in 2-Propanone (Acetone).
3. Ultra-sonication for 10 min. in 2-Propanol (Iso-propanol).
4. Ultra-sonication for 10 min. in de-ionised water.
5. Drying in oven at 100° C. for 8 hours.

Spin Coating of PEDOT-PSS Layer:

A layer of polyethylene dioxythiophene polystyrene sulphonate (PEDOT-PSS) was spin coated onto the ITO/Glass from aqueous solution (Baytron P VPCH 8000 from Bayer).
1. A thin layer (88 nm) of PEDOT-PSS solution was applied to the entire ITO substrate surface.
2. A hot air-gun (1500 W) was directed at the surface of the substrate. The temperature of the substrate was 55° C.
3. Immediately the substrate was spun at 300 rpm for 5 seconds and then 3000 rpm for 15 seconds, after which the hot air flow was immediately ceased.

| Spin Speed (rpm) | Time (s) |
|---|---|
| 300 | 5 |
| 3000 | 15 |

4. The coated thin film was checked for evenness and then dried at 100° C. for 1 hour in a vacuum oven.

Vacuum Coating of α-NPB Layer:

A layer of 40 nm of α-NPB was vacuum coated onto ITO/PEDOT-PSS substrate surface.

12.5% (w/w) Mixture of Compound Q in CBP:

0.35 g of CBP and 0.05 g of Compound Q were mixed and dissolved in 20 ml of 1,4-dioxane.

The solution was filtered to remove any undissolved particles for the spin coating.

Spin Coating of the Compound Q/CBP Mixture Layer:
1. A layer (80 nm) of emitter solution was applied to entire ITO/PEDOT-PSS/α-NPB substrate surface.
2. Immediately the substrate was spun at 200 rpm for 5 seconds and then 2000 rpm for 15 seconds.

| Spin Speed (rpm) | Time (s) |
|---|---|
| 200 | 5 |
| 2000 | 15 |

3. The coated thin film was checked for evenness and then dried at 100° C. for 1 hour in a vacuum oven.

Vacuum Coating of BCP, Alq₃ and LiF Layers:

A layer (6 nm) of BCP, 40 nm of Alq₃ and then 0.5 nm of LiF were vacuum coated onto the ITO/PEDOT-PSS/α-NPB/CBP:Compound Q substrate surface.

Vacuum Coating of Cathode:

Aluminium (Al, 100 nm) was vacuum evaporated onto the ITO/PEDOT-PSS/α-NPB/CBP:Compound Q/BCP/Alq₃/LiF substrate surface.

Device Configuration:

ITO (20 nm)/PEDOT-PSS (88 nm)/α-NPB (40 nm)/CBP:Compound Q (12.5%; 80 nm)/BCP (6 nm)/Alq₃ (40 nm)/LiF (0.5 nm)/Al (100 nm)

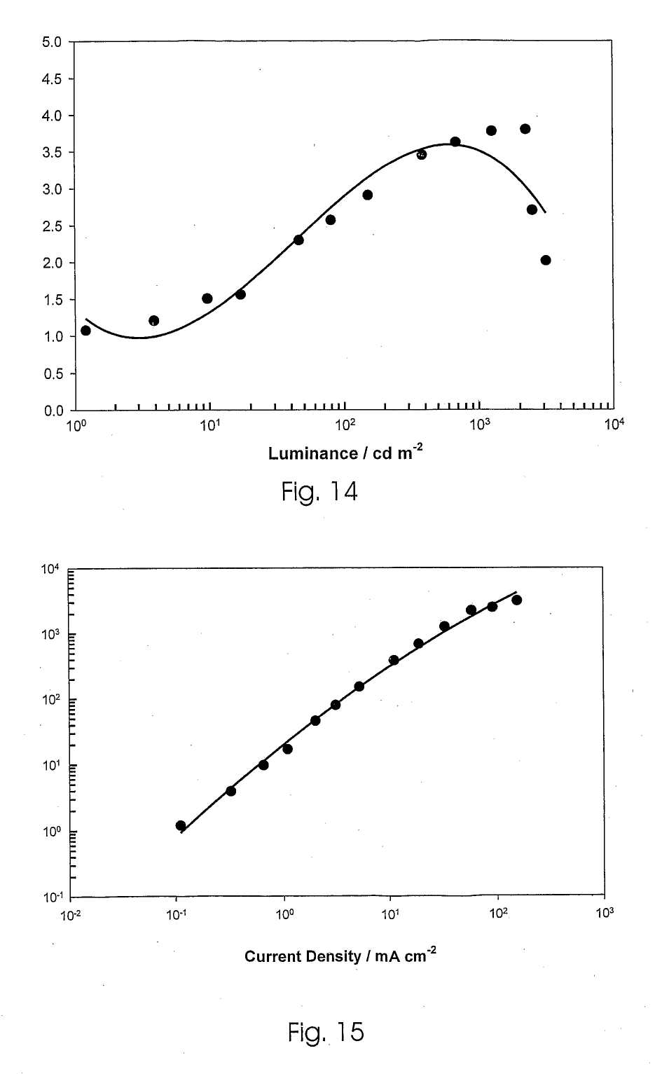

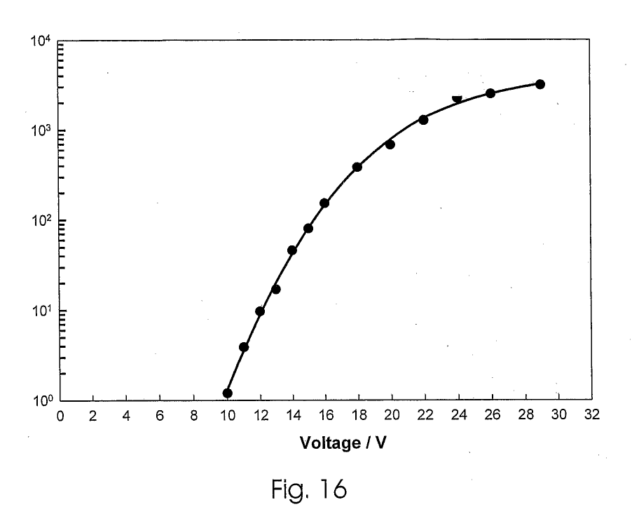

The properties of this device were measured and the results shown in FIGS. 14, 15 and 16.

### Example 4

### Spin Coated Devices Based on Compound R

Compound R is

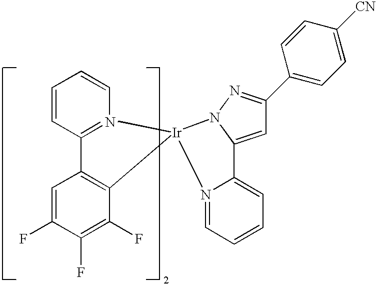

Spin Coater:

Spin coater used was a Semitec CPS 10 with a 6 inch plate.

Preparation of ITO:

ITO (100 Ω□,˜20 nm) coated glass was cleaned using following procedure.
1. Ultra-sonication for 10 min. Ethanol.
2. Ultra-sonication for 10 min. in 2-Propanone (Acetone).
3. Ultra-sonication for 10 min. in 2-Propanol (Iso-propanol).
4. Ultra-sonication for 10 min. in de-ionised water.
5. Drying in oven at 100° C. for 8 hours.

Spin Coating of PEDOT-PSS Layer:

A layer of polyethylene dioxythiophene polystyrene sulphonate (PEDOT-PSS) was spin coated onto the ITO/Glass from aqueous solution (Baytron P VPCH 8000 from Bayer).
1. A thin layer (88 nm) of PEDOT-PSS solution was applied to the entire ITO substrate surface.
2. A hot air-gun (1500 W) was directed at the surface of the substrate. The temperature of the substrate was 55° C.
3. Immediately the substrate was spun at 300 rpm for 5 seconds and then 3000 rpm for 15 seconds, after which the hot air flow was immediately ceased.

| Spin Speed (rpm) | Time (s) |
|---|---|
| 300 | 5 |
| 3000 | 15 |

4. The coated thin film was checked for evenness and then dried at 100° C. for 1 hour in a vacuum oven.

Vacuum Coating of α-NPB Layer:

A layer of 40 nm of α-NPB was vacuum coated onto ITO/PEDOT-PSS substrate surface.

12.5% (w/w) Mixture of Compound R in CBP:

0.35 g of CBP and 0.05 g of Compound R were mixed and dissolved in 20 ml of 1,4-dioxane.

The solution was filtered to remove any undissolved particles for the spin coating.

Spin Coating of the Compound R/CBP Mixture Layer:
1. A layer (75 nm) of emitter solution was applied to entire ITO/PEDOT-PSS/α-NPB substrate surface.
2. Immediately the substrate was spun at 200 rpm for 5 seconds and then 2000 rpm for 15 seconds.

| Spin Speed (rpm) | Time (s) |
|---|---|
| 200 | 5 |
| 2000 | 15 |

3. The coated thin film was checked for evenness and then dried at 100° C. for 1 hour in a vacuum oven.

Vacuum Coating of E101 and LiF Layers:

A layer (10 nm) of E101 and then 0.5 nm of LiF were vacuum coated onto the ITO/PEDOT-PSS/α-NPB/CBP:Compound R substrate surface.

Vacuum Coating of Cathode:

Aluminium (Al, 100 nm) was vacuum evaporated onto the ITO/PEDOT-PSS/α-NPB/CBP:Compound R/E101/LiF substrate surface.

Device Configuration:

ITO (20 nm)/PEDOT-PSS (88 nm)/α-NPB (40 nm)/CBP:Compound R (12.5%; 75 nm)/E101 (10 nm)/LiF (0.5 nm)/Al (100 nm).

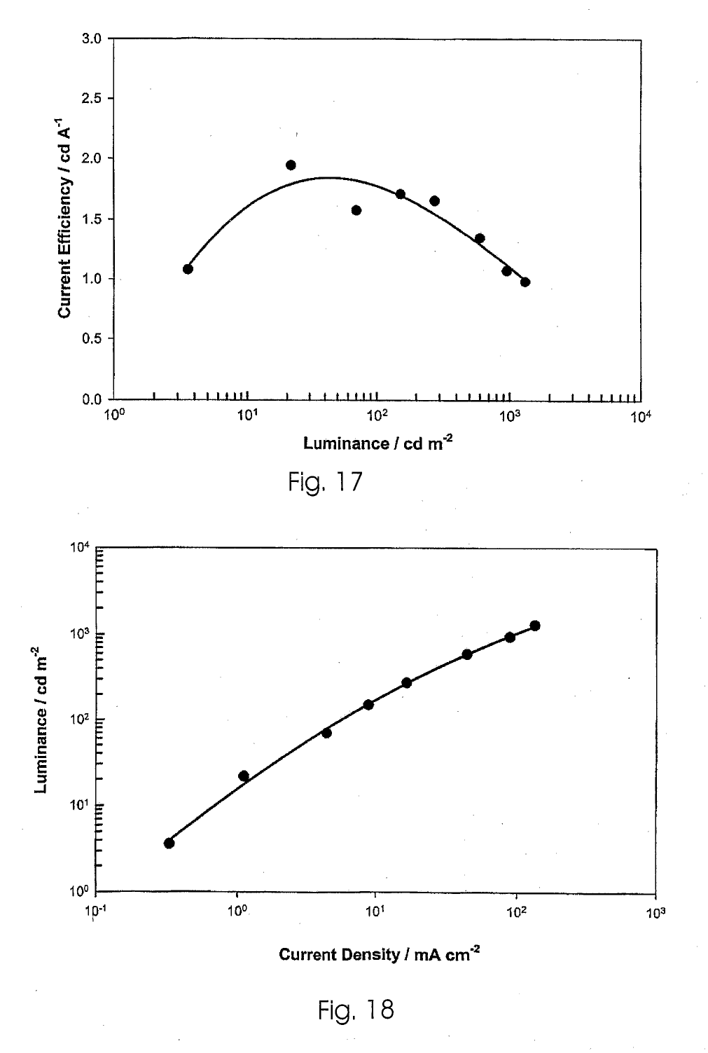

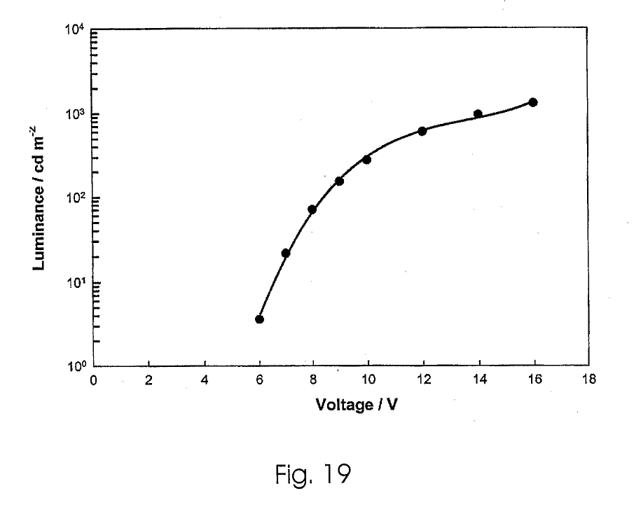

The properties of this device were measured and the results shown in FIGS. 17, 18 and 19.

1-34. (canceled)

35. A method of forming an electroluminescent device which includes at least a substrate that can function as an anode, the method comprising the step of depositing by spin coating a layer of an electroluminescent organometallic complex on the substrate that functions as the anode wherein the substrate has previously been coated with a layer of a polymer.

36. The method of claim 35 wherein the polymer is an electrically conductive polymer which can be dissolved in a solvent.

37. The method of claim 35, wherein the polymer is a conjugated polymer.

38. The method of claim 35, wherein the polymer is a polyethylene dioxythiophene polystyrene sulphonate.

39. The method of claim 35, further comprising the step of depositing a polymer layer having a thickness of about 50 to 150 nanometers on the substrate.

40. The method of claim 35, further wherein there is deposited on the polymer a layer of a material selected from the group consisting of:
a phthalocyanine;
a porphoryin;
a compound having the general chemical formula 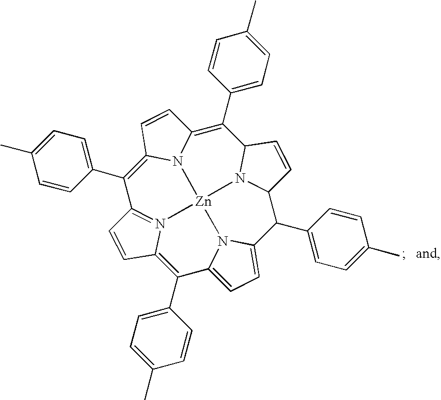
a metal diamino dianthracene having the general chemical formula 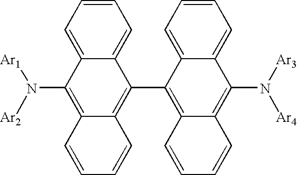
where Ar₁, Ar₂ Ar₃ and Ar₄ are the same or different aromatic groups.

41. The method of claim 35, comprising the steps of sequentially depositing on a transparent anode the following layers:
(1) the layer of a polymer;
(2) a layer of a hole transporting material;
(3) a layer comprising an electroluminescent organometallic complex;
(4) a layer of an electron transmitting material; and
(5) a cathode,
wherein at least the layer of the electroluminescent organometallic complex is deposited by spin coating.

42. The method of claim 41, wherein the step of depositing a layer of a hole transporting material comprises depositing a layer of a hole transporting material selected from the group consisting of α-NBP, poly(vinylcarbazole); N,N′-diphenyl-N,N′-bis (3-methylphenyl)-1,1′-biphenyl-4,4′-diamine (TPD); polyaniline; substituted polyanilines; polythiophenes; substituted polythiophenes; polysilanes; and substituted polysilanes.

43. The method of claim 41, wherein the step of depositing a layer of a hole transporting material is followed by a step of depositing on the hole transporting material any of the following materials:
(a) a complex of ruthenium, rhodium, palladium, osmium, iridium or platinum;
(b) a metallic complex having a general chemical formula selected from the group consisting of: 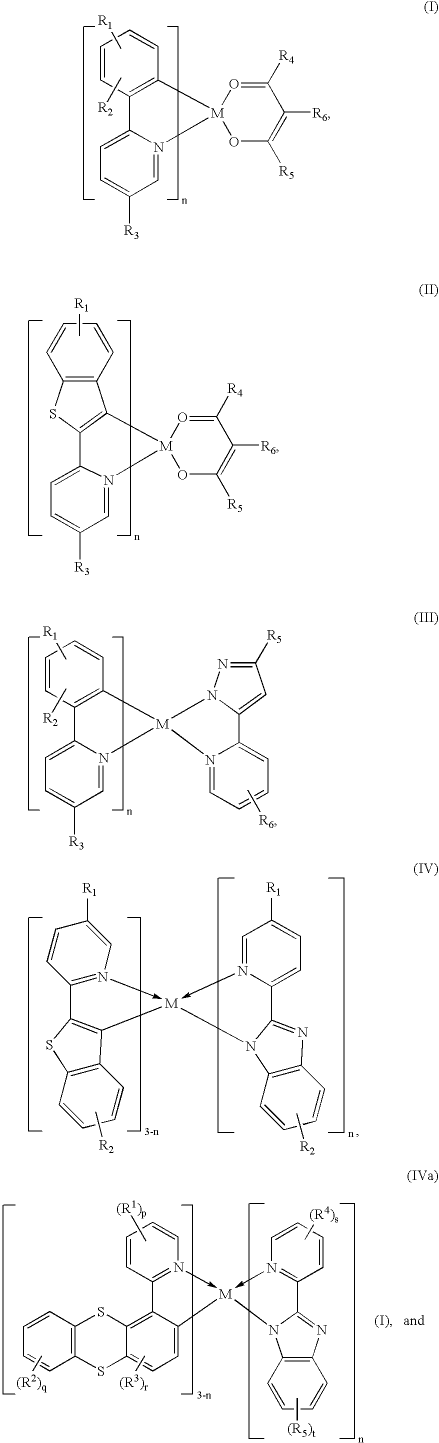 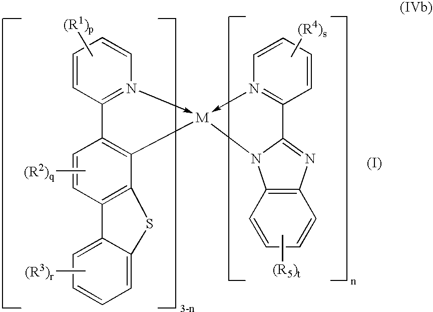
where:
R₁, R₂, R₃, R₄, R₅ and R₆ can be the same or different and are independently selected from hydrogen; substituted and unsubstituted hydrocarbyl groups; substituted and unsubstituted aromatic, heterocyclic and polycyclic ring structures; fluorocarbons; halogens; and thiophenyl groups;
R₁, R₂ and R₃ can also form substituted and unsubstituted fused aromatic, heterocyclic and polycyclic ring structures and can be copolymerisable with a monomer while R₄ and R₅ can be the same or different and are independently selected from hydrogen; substituted and unsubstituted hydrocarbyl groups; substituted and unsubstituted aromatic, heterocyclic and polycyclic ring structures; fluorocarbons; halogens; and thiophenyl groups;
R₁, R₂ and R₃ can also form substituted and unsubstituted fused aromatic, heterocyclic and polycyclic ring structures and can be copolymerisable with a monomer;
M is ruthenium, rhodium, palladium, osmium, iridium or platinum, and n+2 is the valence of M;
(c) an organometallic complex having the general chemical formula M(L)ₙ or MO(L)ₙ₋₂, where M is a metal in a valence state n of greater than 3 and L is an organic ligand, said ligands L being the same or different;
(d) zirconium quinolate; and,
(e) an electroluminescent compound doped with a minor amount of a fluorescent material as a dopant.

44. The method of claim 41, wherein the step of depositing a layer of an electron transmitting material comprises depositing a layer of electron transmitting material selected from the group consisting of aluminum quinolate; zirconium quinolate; lithium quinolate; Bebq; Balq1; ZnPBO; ZnPBT; DTVb1; t-Bu-PBD; BNDn OXD-7a; a material having the general chemical formula Mx(DBM)ₙ where Mx is a metal, DBM is dibenzoyl methane, and n is the valency of Mx; a cyanoanthracene; and a polystyrene sulphonate.
